(19) United States
(12) Patent Application Publication
(10) Pub. No.: US 2022/0129579 A1
(43) Pub. Date: Apr. 28, 2022

(54) METHOD AND APPARATUS FOR PROVIDING METERING INFORMATION THAT PROVIDES SECURITY FOR PERSONAL INFORMATION

(71) Applicant: ELECTRONICS AND TELECOMMUNICATIONS RESEARCH INSTITUTE, Daejeon (KR)

(72) Inventors: Chang-Sic CHOI, Daejeon (KR); Dae Geun PARK, Daejeon (KR); Wan Ki PARK, Daejeon (KR); Jinsoo HAN, Daejeon (KR)

(21) Appl. No.: 17/498,802

(22) Filed: Oct. 12, 2021

(30) Foreign Application Priority Data
Oct. 28, 2020 (KR) 10-2020-0140969
May 24, 2021 (KR) 10-2021-0066145

(51) Int. Cl. G06F 21/62; H04L 29/06; G06Q 50/06

(52) U.S. Cl. CPC G06F 21/6245; G06Q 50/06; H04L 63/083; H04L 63/0823

(57) ABSTRACT

Disclosed is a method and apparatus for providing metering information that may provide a security for personal information. A metering information providing method collects metering information about a variety of energy, such as electricity, gas, heating, cooling, and hot water of an apartment house, provides the collected metering information to a utility provider and an energy information provider, and provides a systematic security function of personal information required to operate a new business model.

### CROSS-REFERENCE TO RELATED APPLICATIONS

This application claims the benefit of Korean Patent Application No. 10-2020-0140969 filed on Oct. 28, 2020, and Korean Patent Application No. 10-2021-0066145 filed on May 24, 2021, in the Korean Intellectual Property Office, the entire disclosures of which are incorporated herein by reference for all purposes.

### BACKGROUND

### 1. Field of the Invention

One or more example embodiments relate to a metering information providing method and apparatus that may provide security about personal information, and more particularly, to an apparatus and method for providing a security function of personal information exposed in each of processes of collecting and storing metering information about energy used in each individual household of an apartment house and providing a service.

### 2. Description of Related Art

An existing billing service related to energy used in an apartment house collects metering information installed in a plurality of household subscribers, stores the collected metering information in a database linked to an apartment management server, and provides billing and statistical information of the apartment house based on the monthly usage. A utility provider of, for example, electricity, gas, heating and air conditioning, and hot water depends on passive information that is provided from an on-site server administrator, or builds a separate metering infrastructure to be used for billing. Energy use information used in apartment houses may be utilized as data of a new energy business model by utility providers. A system for providing metering information of an apartment house is required to prevent redundant investment and directly link metering information.

Such an apartment house-based metering information providing system requires a secure and reliable collection, storage, and service provision for collected data and it is necessary to apply a security process from an apartment house metering server to a service section that is provided to an external utility provider. However, the metering information providing system may cause loss of personal information and unauthorized access to energy consumption data in the above process. In particular, there is a high risk of exposing energy use information and personal information.

### SUMMARY

Example embodiments provide a metering information providing method and apparatus that may provide a security function for personal information essential to operate an energy business model and to provide existing closed metering information of an apartment house to various utility providers.

Example embodiments provide a metering information providing method and apparatus that may protect personal information such that metering information collected, managed, and operated in an apartment house may be securely linked to external providers and development and dissemination of energy-related business models may be actively performed accordingly.

According to an aspect, there is provided a metering information providing method including collecting, from an apartment house metering server, metering information about energy used in each individual household that constitutes an apartment house; determining an encryption scheme applicable to the metering information of each individual household based on a security level of the collected metering information of each individual household; encrypting the metering information of each individual household according to the determined encryption scheme; and in response to a data retrieval request for the encrypted metering information, providing the encrypted metering information using a security certificate.

The collecting of the metering information may include collecting metering information in a one-way form in which personal information of each individual household is included from the apartment house metering server.

The determining of the encryption scheme may include determining whether a personal password is set to the metering information by a user and determining the security level of the metering information as one of a general security and a privacy security.

The determining of the encryption scheme may include, when the security level of the metering information is determined as the general security, determining the encryption scheme applicable to the metering information of each individual household as a one-way encryption scheme that does not require decryption.

The determining of the encryption scheme may include, when the security level of the metering information is determined as the privacy security, determining the encryption scheme applicable to the metering information of each individual household as a two-way encryption scheme that requires decryption.

The encrypting of the metering information may include encrypting the metering information of each individual household according to the determined encryption scheme in conjunction with a database, and the encrypted metering information may be stored in the database and retrieved through an encryption algorithm.

The providing of the encrypted metering information may include receiving search information related to the metering information from a service device corresponding to the data retrieval request; extracting at least one metering information that satisfies the search information in the encrypted metering information; and decrypting the extracted metering information using a security certificate applicable to the service device and then providing the decrypted metering information to the service device.

Additional aspects of example embodiments will be set forth in part in the description which follows and, in part, will be apparent from the description, or may be learned by practice of the disclosure.

According to example embodiments, a metering information providing method may classify a security section into three stages, for example, a collection stage, a storage stage, and a providing state, to more securely manage data without rebuilding an on-site metering server that interacts with an apartment house and may provide a security function with a level suitable for a characteristic of each stage.

Also, according to example embodiments, a metering information providing method may support a more secure and flexible external interface by providing a web-based interface, a Rest-API-based interface, a web socket-based interface, etc., with a security function according to a characteristic of a target user such as an external utility provider, a general user, and an apartment manager.

Also, according to example embodiments, a metering information providing method may be used in preparation for energy rate plans and integrated energy management that are expected to be diversified in the future.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating an overall configuration of a metering information providing apparatus that provides a security for personal information according to an example embodiment;

FIG. 2 illustrates a configuration to describe an operation of a metering information providing apparatus that collects metering information according to an example embodiment;

FIG. 3 illustrates a configuration to describe an operation of a metering information providing apparatus that stores metering information according to an example embodiment;

FIG. 4 illustrates a configuration to describe an operation of a metering information providing apparatus that provides metering information according to an example embodiment; and

FIG. 5 is a flowchart illustrating a metering information providing method according to an example embodiment.

### DETAILED DESCRIPTION

Hereinafter, example embodiments will be described in detail with reference to the accompanying drawings.

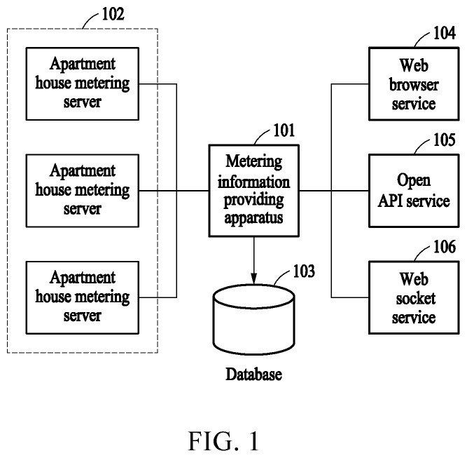

FIG. 1 is a diagram illustrating an overall configuration of a metering information providing apparatus that provides a security for personal information according to an example embodiment.

Referring to FIG. 1, a metering information providing apparatus 101 may collect, from an apartment house metering server 102, metering information about energy used in each individual household constituting an apartment house. Also, the metering information providing apparatus 101 may more securely store and manage the collected metering information in a database 103. In response to receiving a retrieval request message from a service provider, the metering information providing apparatus 101 may provide metering information with protected personal information to the service provider.

In detail, the metering information providing apparatus 101 may securely manage the metering information in the apartment house through a plurality of security stages to overcome a security issue required to provide a service of metering information about the energy used in the apartment house. The metering information providing apparatus 101 may provide the metering information stored in the apartment house metering server 102 interacting with the apartment house to a variety of service devices. Here, the metering information providing apparatus 101 may support a service to be securely provided through each security stage. Here, the service may include, for example, a web browser service 104, an open application programming interface (API) service 105, and a web socket service 106.

A service device may request the metering information providing apparatus 101 to provide the metering information in order to operate a business model from the service provider. The service provider may include, for example, an external utility provider and an energy information provider. The metering information providing apparatus 101 may apply a security stage for the personal information included in the metering information in a process of providing the metering information in response to a request from the service device and may provide the metering information to the service device in a more secure manner accordingly.

The security stage proposed herein may be largely divided into a first security section, a second security section, and a third security section, and may be implemented with a security function suitable for each section. In detail, the first security section may represent a security section of collecting, from the apartment house metering server 102, metering information about energy used in each individual household constituting the apartment house. Here, the second security section may represent a security section of storing the metering information collected from the apartment house metering server 102 in the database 103. Also, the third security section may represent a security section of securely providing the metering information in response to a request from the service provider.

Therefore, the metering information providing apparatus 101 may perform each security stage such that the personal information included in the metering information may not be distributed to other users and may provide the metering information to the service provider while further securely protecting the personal information and the metering information accordingly. Also, the metering information providing apparatus 101 may provide, to a variety of services, metering information that is no more usable by the apartment house metering server 102 once a fee settlement is made by an apartment house manager.

Accordingly, the metering information providing apparatus 101 may provide security for the personal information included in the metering information by protecting the metering information collected through the sub-divided security stage. The method proposed herein may be used in preparation for an energy rate plans and integrated energy management that are expected to be diversified in the future and also may be used for development and dissemination of energy-related business models.

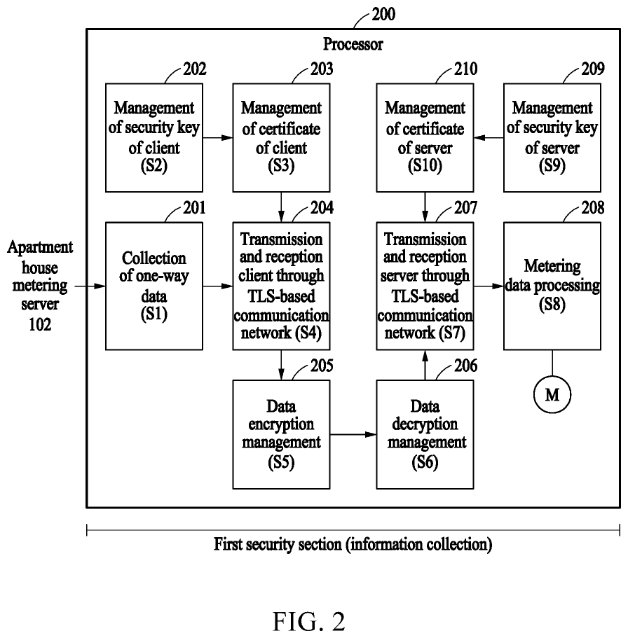

FIG. 2 illustrates a configuration to describe an operation of a metering information providing apparatus that collects metering information according to an example embodiment.

Referring to FIG. 2, the metering information providing apparatus 101 may include a processor 200 configured to collect metering information in the first security section. The processor 200 may collect the metering information largely in terms of a client and in terms of a server.

\textcircled{1} In terms of a client:

In S1 201, the processor 200 may collect metering information in a one-way form from the apartment house metering server 102. The processor 200 may collect the metering information of each individual household of the apartment house in a one-way form from the apartment house metering server 102. Here, the processor 200 may collect the metering information through restrictions, such as, for example, a read-only permission.

In S2 202, the processor 200 may manage a security key of the client. For connection to a server, the processor 200 may manage a symmetric key to be used for encrypting and decrypting data and a public key and a secret key to be used for generating and verifying a certificate.

In S3 203, the processor 200 may manage a certificate of the client. The processor 200 may perform a function of generating and revoking an individual certificate used for mutual authentication, such as ID verification and counterpart certificate verification.

In S4 204, the processor 200 may refer to a client module, and may perform an authentication function and transmit encrypted metering information through a transport layer security (TLS)-based communication network according to a client-server method.

In S5 205, the processor 200 may encrypt the collected metering information to protect the personal information included in the metering information in the process (S4) of transmitting and receiving the metering information. The processor 200 may encrypt the metering information to prevent data leakage and ensure confidentiality when transmitting the metering information from the client to the server through the TLS-based communication network.

When the processor 200 operates in terms of the client, the processor 200 may interact with a different metering information providing apparatus that operates as a server module. Here, the processor 200 may communicate with the different metering information providing apparatus through a client-server-based communication network. The processor 200 may transmit the encrypted metering information to the different metering information providing apparatus that operates as the server module through the aforementioned process (S1 to S5).

\textcircled{2} In terms of the server:

In S7 207, the processor 200 may refer to the server module and may receive the encrypted metering information through the TLS-based communication network according to the client-server method. Here, the processor 200 may receive the encrypted metering information from the different metering information providing apparatus that operates in terms of the client. The encrypted metering information may be in a state in which the authentication function for information is performed through a series of processes performed in the different metering information providing apparatus that operates in terms of the client.

In S9 209, the processor 200 may manage a security key of the server. For connection to the client, the processor 200 may manage a symmetric key to be used for encrypting and decrypting data and a public key and a secret key to be used for generating and verifying a certificate.

In S10 210, the processor 200 may manage a certificate of the server. The processor 200 may perform a function of generating and revoking an individual certificate used for mutual authentication, such as ID verification and counterpart certificate verification.

In S6 206, the processor 200 may decrypt the encrypted metering information to prevent data leakage and ensure confidentiality of the metering information transmitted from the client.

In S8 208, the processor 200 may classify an encryption target by considering a security level of each metering information transmitted from the client.

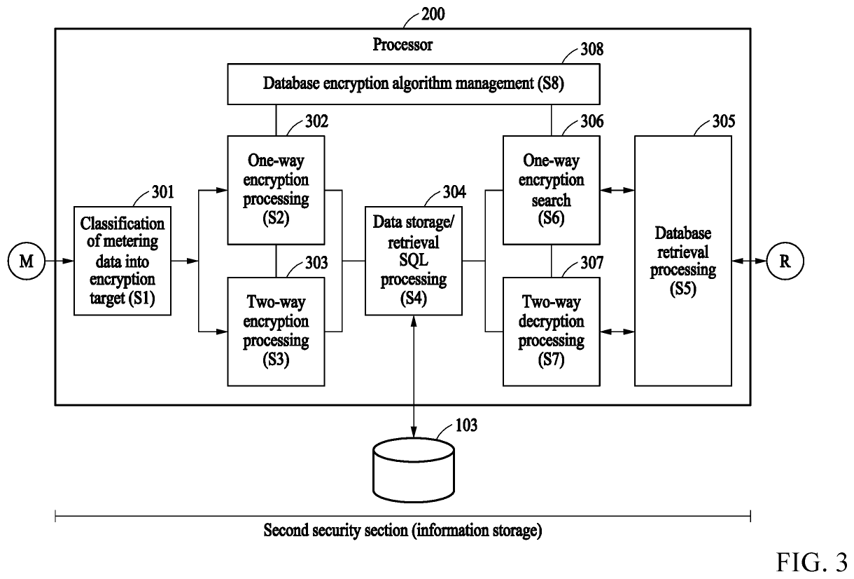

FIG. 3 illustrates a configuration to describe an operation of a metering information providing apparatus that stores metering information according to an example embodiment.

Referring to FIG. 3, the metering information providing apparatus 101 may include the processor 200 configured to store and retrieve metering information in the second security section. The processor 200 may manage the metering information largely in terms of storage and in terms of retrieval.

\textcircled{1} In terms of storage:

The processor 200 may perform a security function in a process of storing metering information about energy used in the apartment house collected through the client in the database 103.

In S1 301, the processor 200 may classify metering information decrypted in an information collection process of FIG. 2. The processor 200 may determine an encryption scheme applicable to metering information of each individual household based on a security level of the collected metering information of each individual household. Here, the processor 200 may determine whether a personal password is set to the metering information by a user and may determine the security level of the metering information as one of a general security and a privacy security.

In S2 302, when the security level of the metering information is determined as the general security, the processor 200 may process the corresponding metering information using a one-way encryption scheme. Here, the metering information determined as the general security may be data that does not need to be decrypted and is useful for verification, such as the personal password.

In S3 303, when the security level of the metering information is determined as the privacy security, the processor 200 may process the corresponding metering information using a two-way encryption scheme. Here, the metering information determined as the privacy security may be data that needs to be decrypted since the data includes personal information of which leakage to an outside is to be prevented.

In S4 304, the processor 200 may store the metering information to which the one-way encryption scheme or the two-way encryption scheme is applied using a structured query language (SQL). The metering information stored in the database 103 may be used for external services, for example, the web browser service 104, the open API service 105, and the web socket service 106.

\textcircled{2} In terms of retrieval:

The processor 200 may retrieve the metering information in response to a retrieval request message and may perform an SQL-related processing function.

In S5 305, in response to a retrieval request for the metering information from an external service according to a utility provider and an energy information provider, the processor 200 may classify a retrieval scheme of the requested metering information. That is, the processor 200 may classify the retrieval scheme of the metering information into one of a one-way encryption search and a two-way decryption processing according to the security level of the metering information.

In S6 306, in the case of retrieving the metering information using the one-way encryption search, the processor 200 may verify metering information in a one-way form, which cannot be decrypted.

In S7 307, in the case of retrieving the metering information using the two-way decryption processing, the processor 200 may decrypt the encrypted metering information and may verify the decrypted metering information.

In S4 304, the processor 200 may retrieve the metering information stored in the database 103 using the SQL according to the retrieval scheme of the metering information.

In S8 308, the processor 200 may provide a coherent encryption management function through database encryption algorithm management in setting an encryption-related algorithm of a process (302, 303, 306, 307) related to a one-way encryption and a two-way encryption of FIG. 3.

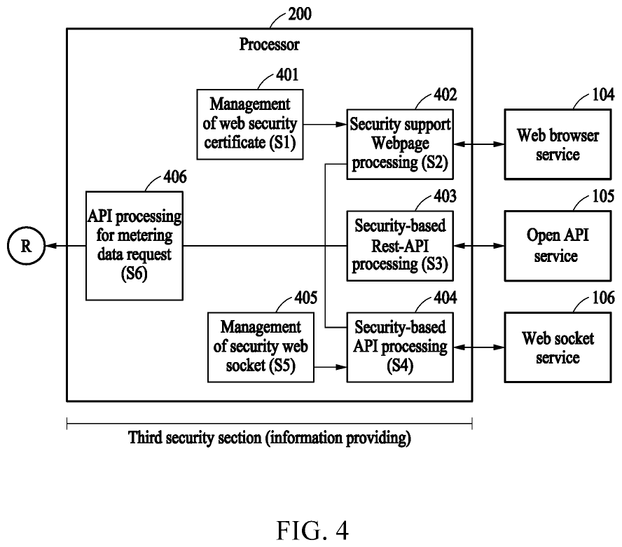

FIG. 4 illustrates a configuration to describe an operation of a metering information providing apparatus that provides metering information according to an example embodiment.

Referring to FIG. 4, the metering information providing apparatus 101 may include the processor 200 configured to provide metering information in the third security section. The processor 200 may securely provide the metering information to each service in response to a request from a service provider. That is, the processor 200 may securely provide a security function for personal information and energy data in response to a data retrieval request from various services, for example, the web browser service 104, the open API service 105, and the web socket service 106, such that an external provider and a user may use the metering information.

In S1 401, the processor 200 may manage a web security certificate to ensure the security of a web server.

In S2 402, the processor 200 may receive a retrieval request message for retrieving metering information from the web browser service 104. The processor 200 may support a webpage processing using the web security certificate according to the retrieval request message. Here, the web browser service 104 may provide the security function using the metering information through a webpage that uses HTTPS based on the web security certificate.

In S3 403, the processor 200 may receive a retrieval request message for retrieving metering information from the open API service 105. The processor 200 may support security-based Rest-API that is performed with encryption according to the retrieval request message.

In S4 404, the processor 200 may receive a retrieval request message for retrieving metering information from the web socket service 106. The processor 200 may provide an open-SSL-based web socket interface and may easily support an application of an external user server to easily retrieve energy data. In S5 405, the processor 200 may manage a security web socket and, through this, may provide an encryption function.

In S6 406, the processor 200 may retrieve and provide metering information in conjunction with the database 103 in response to a retrieval request message for each of various services, for example, the web browser service 104, the open API service 105, and the web socket service 106. The processor 200 may integrate, retrieve, and manage the metering information based on an API.

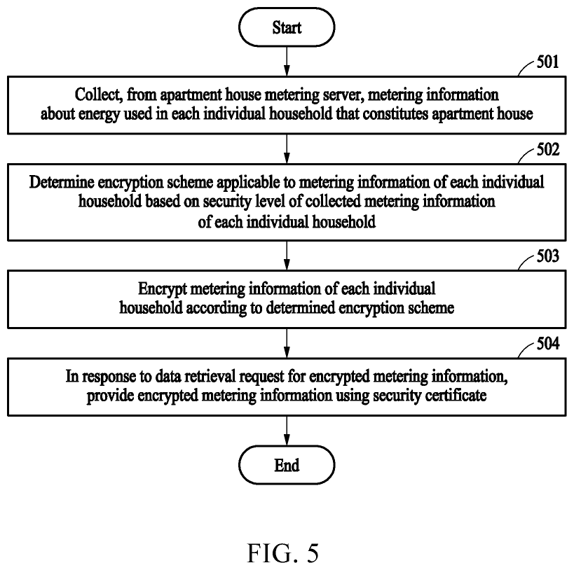

FIG. 5 is a flowchart illustrating a metering information providing method according to an example embodiment.

Referring to FIG. 5, in operation 501, a metering information providing apparatus may collect, from an apartment house metering server, metering information about energy used in each individual household that constitutes an apartment house. The metering information providing apparatus may collect metering information in a one-way form in which personal information of each individual household is included from the apartment house metering server.

In operation 502, the metering information providing apparatus may determine an encryption scheme applicable to the metering information of each individual household based on a security level of the collected metering information of each individual household. The metering information providing apparatus may determine whether a personal password is set to the metering information by a user and may determine the security level of the metering information as one of a general security and a privacy security.

When the security level of the metering information is determined as the general security, the metering information providing apparatus may determine the encryption scheme applicable to the metering information of each individual household as a one-way encryption scheme that does not require decryption. Also, when the security level is determined as the privacy security, the metering information providing apparatus may determine the encryption scheme applicable to the metering information of each individual household as a two-way encryption scheme that requires decryption.

In operation 503, the metering information providing apparatus may encrypt the metering information of each individual household according to the determined encryption scheme. The metering information providing apparatus may encrypt the metering information of each individual household according to the encryption scheme in conjunction with a database. The encrypted metering information may be stored in the database and retrieved through an encryption algorithm.

In operation 504, in response to a data retrieval request for the encrypted metering information, the metering information providing apparatus may provide the encrypted metering information using a security certificate. The metering information providing apparatus may receive search information related to the metering information from a service device corresponding to the data retrieval request and may extract at least one metering information that satisfies the search information in the encrypted metering information. The metering information providing apparatus may decrypt the metering information using a security certificate applicable to the service device and then provide the decrypted metering information to the service device.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific example embodiments, the details should not be construed as limiting any invention or a scope that can be claimed, but rather should be construed as being descriptions of features that may be peculiar to specific example embodiments of specific inventions. Specific features described in the present specification in the context of individual example embodiments may be combined and implemented in a single example embodiment. On the contrary, various features described in the context of a single embodiment may be implemented in a plurality of example embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In a specific case, multitasking and parallel processing may be advantageous. In addition, it should not be understood that the separation of various device components of the aforementioned example embodiments is required for all the example embodiments, and it should be understood that the aforementioned program components and apparatuses may be integrated into a single software product or packaged into multiple software products.

The example embodiments disclosed in the present specification and the drawings are intended merely to present specific examples in order to aid in understanding of the present disclosure, but are not intended to limit the scope of the present disclosure. It will be apparent to those skilled in the art that various modifications based on the technical spirit of the present disclosure, as well as the disclosed example embodiments, can be made.

What is claimed is:

1. A method of providing metering information, the method comprising:
collecting encrypted metering information of each of individual households that constitute an apartment house from an apartment house metering server and decrypting the encrypted metering information;
determining an encryption scheme applicable to the decrypted metering information, and classifying and encrypting the decrypted metering information according to the determined encryption scheme; and
in response to a retrieval request for the encrypted metering information, providing the encrypted metering information through a different interface according to a service device.

2. The method of claim 1, wherein the decrypting of the encrypted metering information comprises collecting, from the apartment house metering server, metering information in which personal information of each of the individual households that constitute the apartment house is encrypted.

3. The method of claim 1, wherein the decrypting of the encrypted metering information comprises:
decrypting the encrypted metering information by performing authentication on the metering information through a client-server-based certificate.

4. The method of claim 1, wherein the encrypting comprises:
determining a security level of the decrypted metering information based on presence or absence of a personal password set to the decrypted metering information; and
determining the encryption scheme applicable to the decrypted metering information based on the security level of the metering information.

5. The method of claim 4, wherein the security level of the metering information is divided into a general security without the personal password being set and a privacy security with the personal password being set and including personal information of each individual household.

6. The method of claim 5, wherein the encrypting comprises, when the security level is determined as the general security, determining the encryption scheme applicable to the decrypted metering information as a one-way encryption scheme that does not require decryption.

7. The method of claim 5, wherein the encrypting comprises, when the security level is determined as the privacy security, determining the encryption scheme applicable to the decrypted metering information as a two-way encryption scheme that requires decryption.

8. The method of claim 1, wherein:
the encrypting comprises classifying the decrypted metering information according to the determined encryption scheme and encrypting the decrypted metering information classified into each group in conjunction with a database, and
the encrypted metering information is stored in the database and, in response to a retrieval request, is retrieved through an encryption algorithm.

9. The method of claim 8, wherein the decrypting and the providing comprises:
receiving search information related to metering information from the service device corresponding to the retrieval request;
extracting at least one metering information that satisfies the search information in the encrypted metering information in conjunction through the database; and
providing the metering information to the service device through the different interface into consideration of an encryption scheme of the extracted metering information.

10. The method of claim 9, wherein the providing of the extracted metering information to the service device comprises, when the encryption scheme is a privacy security, decrypting the extracted metering information and providing the decrypted metering information to the service device.

11. A metering information providing apparatus comprising a processor, wherein the processor is configured to:
collect encrypted metering information of each of individual households that constitute an apartment house from an apartment house metering server and decrypt the encrypted metering information,
determine an encryption scheme applicable to the decrypted metering information, and classify and encrypt the decrypted metering information according to the determined encryption scheme, and
in response to a retrieval request for the encrypted metering information, provide the encrypted metering information through a different interface according to a service device.

12. The metering information providing apparatus of claim 11, wherein the processor is configured to collect, from the apartment house metering server, metering information in which personal information of each of the individual households that constitute the apartment house is encrypted.

13. The metering information providing apparatus of claim 11, wherein the processor is configured to decrypt the encrypted metering information by performing authentication on the metering information through a client-server-based certificate.

14. The metering information providing apparatus of claim 11, wherein the processor is configured to:
determine a security level of the decrypted metering information based on presence or absence of a personal password set to the decrypted metering information, and
determine the encryption scheme applicable to the decrypted metering information based on the security level of the metering information.

15. The metering information providing apparatus of claim 14, wherein the security level of the metering information is divided into a general security without the personal password being set and a privacy security with the personal password being set and including personal information of each individual household.

16. The metering information providing apparatus of claim 15, wherein the processor is configured to, when the security level is determined as the general security, determine the encryption scheme applicable to the decrypted metering information as a one-way encryption scheme that does not require decryption.

17. The metering information providing apparatus of claim 15, wherein the processor is configured to, when the security level is determined as the privacy security, determine the encryption scheme applicable to the decrypted metering information as a two-way encryption scheme that requires decryption.

18. The metering information providing apparatus of claim 11, wherein:
the processor is configured to classify the decrypted metering information according to the determined encryption scheme and encrypt the decrypted metering information classified into each group in conjunction with a database, and
the encrypted metering information is stored in the database and, in response to a retrieval request, is retrieved through an encryption algorithm.

19. The metering information providing apparatus of claim 18, wherein the processor is configured to:
receive search information related to metering information from the service that corresponding to the retrieval request,
extract at least one metering information that satisfies the search information in the encrypted metering information in conjunction through the database, and
provide the extracted metering information to the service device through the different interface into consideration of an encryption scheme of the extracted metering information.

20. The metering information providing apparatus of claim 19, wherein the processor is configured to, when the encryption scheme is a privacy security, decrypt the extracted metering information and provide the decrypted metering information to the service device.
